(19) United States
(12) Patent Application Publication
(10) Pub. No.: US 2025/0142467 A1
(43) Pub. Date: May 1, 2025

(54) ELECTRONIC DEVICE FOR SELECTING ACCESS POINT TO TRANSMIT PROBE RESPONSE FRAME AND METHOD OF OPERATING THE SAME

(71) Applicant: SAMSUNG ELECTRONICS CO., LTD., Suwon-si (KR)

(72) Inventor: Hyeonu CHOI, Suwon-si (KR)

(21) Appl. No.: 18/949,760

(22) Filed: Nov. 15, 2024

Related U.S. Application Data
(63) Continuation of application No. PCT/KR2024/016095, filed on Oct. 22, 2024.

(30) Foreign Application Priority Data
Oct. 27, 2023 (KR) 10-2023-0145903
Dec. 18, 2023 (KR) 10-2023-0184629

(51) Int. Cl. H04W 48/20; H04W 24/08; H04W 84/12

(52) U.S. Cl. CPC H04W 48/20; H04W 24/08; H04W 84/12

(57) ABSTRACT

In an electronic device and a method according to the present disclosure the device may include a communication circuit; a processor; and a memory, wherein the memory may be configured to store instructions that, when executed by the processor, cause the electronic device to receive, from each of at least one access point (AP) that has received a probe request frame transmitted by an external electronic device, information related to the probe request frame, the information including a quality of a signal including the probe request frame, to select a AP among the at least one AP to transmit a probe response frame to the external electronic device based on the signal quality and a data size temporarily stored in a buffer of the at least one AP, and to instruct the selected AP to transmit the probe response frame to the external electronic device.

### CROSS-REFERENCE TO RELATED APPLICATIONS

This application is a continuation application of International Application No. PCT/KR2024/016095 designating the United States, filed on Oct. 22, 2024, in the Korean Intellectual Property Office and claiming priority to Korean Patent Application No. 10-2023-0145903, filed on Oct. 27, 2023, in the Korean Intellectual Property Office and Korean Patent Application Number 10-2023-0184629, filed on Dec. 18, 2023, in the Korean Intellectual Property Office. The disclosures of each of these applications are incorporated by reference herein in their entireties.

### TECHNICAL FIELD

The disclosure relates to an electronic device and a method of operating the electronic device, and to technology for selecting an Access point (AP) to transmit a probe response frame.

### BACKGROUND

With the spread of various electronic devices, improvements in the speed of wireless communication that various electronic devices may use have been implemented. Among wireless communications supported by recent electronic devices, IEEE 802.11 WLAN (or Wi-Fi) is a standard for implementing high-speed wireless connections on various electronic devices. The first implementation of Wi-Fi could support transmission rates of up to 1 to 9 Mbps, but Wi-Fi 6 technology (or IEEE 802.11ax) may support transmission rates of up to approximately 10 Gbps.

Electronic devices may support various services using relatively large amounts of data (e.g., UHD video streaming service, augmented reality (AR) service, virtual reality (VR) service, and/or mixed reality (MR) service) through wireless communications supporting high transmission rates, and may also support various other services. For example, electronic devices may support a service that determines a location thereof through short-distance wireless communication, and it is expected to provide convenience to users of the electronic device by providing various services according to the location of the electronic device.

In IEEE 802.11, discussions are underway regarding multi-AP coordination, which is a method that can provide data transmission and/or reception through a plurality of APs.

### DISCLOSURE

At least one AP included in multi-AP coordination may receive a probe request frame transmitted by an external electronic device to perform the station (STA) role. An AP that has received the probe request frame may transmit a probe response frame to enable the external electronic device performing the STA role to connect to the AP.

At least one AP included in multi-AP coordination may transmit and/or receive data through the same frequency band (or the same wireless channel) in terms of efficiency of data transmission and/or reception. Transmission of the probe response frame may also be performed through the same frequency band (or the same wireless channel).

However, as the number of external electronic devices transmitting probe request frames and the number of APs receiving probe request frames increase, the number of transmissions of probe response frames may also increase. An increase in the number of transmissions of the probe response frame may increase the congestion in a wireless channel used for transmission and/or reception of the probe response frame and data.

Technical problems to be achieved in this document are not limited to the above-described technical problems, but other technical problems not described will be clearly understood by those skilled in the art from the description below.

According to an embodiment, an electronic device may include a communication circuit. The electronic device may include a processor. The electronic device may include a memory. The memory may store instructions that, when executed by the processor, cause the electronic device to receive information related to a probe request frame including a quality of a signal including the probe request frame from each of at least one access point (AP) that has received the probe request frame transmitted by an external electronic device. The memory may store instructions that cause the electronic device to select an AP to transmit a probe response frame to the external electronic device 220 based on a quality of the signal and a size of data temporarily stored in a buffer of the at least one AP. The memory may store instructions that cause the electronic device to control the selected AP so that the selected AP transmits the probe response frame to the external electronic device 220.

According to an embodiment, a method of operating an electronic device may include receiving information related to a probe request frame including a quality of a signal including the probe request frame from each of at least one access point (AP) that has received the probe request frame transmitted by an external electronic device. The method of operating an electronic device may include selecting an AP to transmit a probe response frame to the external electronic device based on a quality of the signal and a size of data temporarily stored in a buffer of the at least one AP. The method of operating an electronic device may include controlling the selected AP so that the selected AP transmits the probe response frame to the external electronic device.

### ADVANTAGEOUS EFFECTS

According to an embodiment, an electronic device and a method of operating the electronic device can receive information related to a probe request frame including a quality of a signal including the probe request frame from at least one AP and select an AP to transmit the probe response frame based on a quality of the signal, and a status of a buffer of the AP. The electronic device can configure a selected AP to transmit the probe response frame instead of all APs that have received the probe request frame transmitting the probe response frame, thereby preventing an increase in congestion in a wireless channel due to transmission of the probe response frame.

According to an embodiment, an electronic device and a method of operating the electronic device can enable each of at least one AP that has received a probe request frame to transmit a probe response frame including a quality of a measured signal to the electronic device that has transmitted the probe request frame. The electronic device that has received the probe response frame may select an AP to be connected based on the quality of the signal. An AP that has transmitted the probe response frame may be different from an AP connected to the electronic device that has transmitted the probe request frame. Accordingly, the electronic device can enable an electronic device that has transmitted the probe request frame to be connected to an AP that can exhibit the best performance while preventing a plurality of unnecessary transmissions of probe response frames.

Effects that can be obtained from the disclosure are not limited to the above-described effects, and other effects not described will be clearly understood by those of ordinary skill in the art to which the disclosure belongs from the description below.

### BRIEF DESCRIPTION OF DRAWINGS

FIG. 1 is a block diagram illustrating an electronic device according to various embodiments of the disclosure.

FIG. 2A is a diagram illustrating a first electronic device, at least one AP, and a second electronic device according to an embodiment.

FIG. 2B is a diagram illustrating an example in which a second electronic device broadcasts a probe request frame according to an embodiment.

FIG. 3 is a block diagram illustrating a first electronic device according to an embodiment.

FIG. 4 is a diagram illustrating an example in which a first electronic device selects an AP to transmit a probe response frame based on a quality of a signal including the probe request frame according to an embodiment.

FIG. 5 is a diagram illustrating an example in which a first electronic device selects an AP to transmit a probe response frame based on a quality of a signal including the probe request frame and a status of a buffer of at least one AP according to an embodiment.

FIG. 6 is a diagram illustrating an example in which a first electronic device controls a selected AP to transmit a probe response frame according to an embodiment.

FIG. 7 is a block diagram illustrating a second electronic device according to an embodiment.

FIG. 8 is a flowchart illustrating a method of operating an electronic device according to an embodiment.

FIG. 9 is a flowchart illustrating a method of operating an electronic device according to an embodiment.

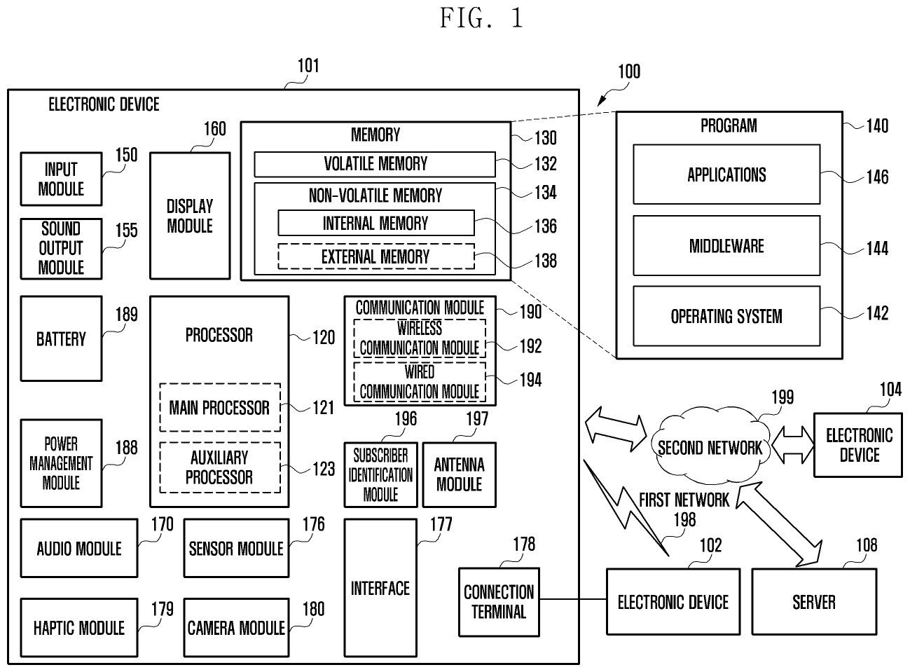

FIG. 1 is a block diagram illustrating an electronic device 101 in a network environment 100 according to various embodiments. Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to one embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an internet-of-things (IOT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

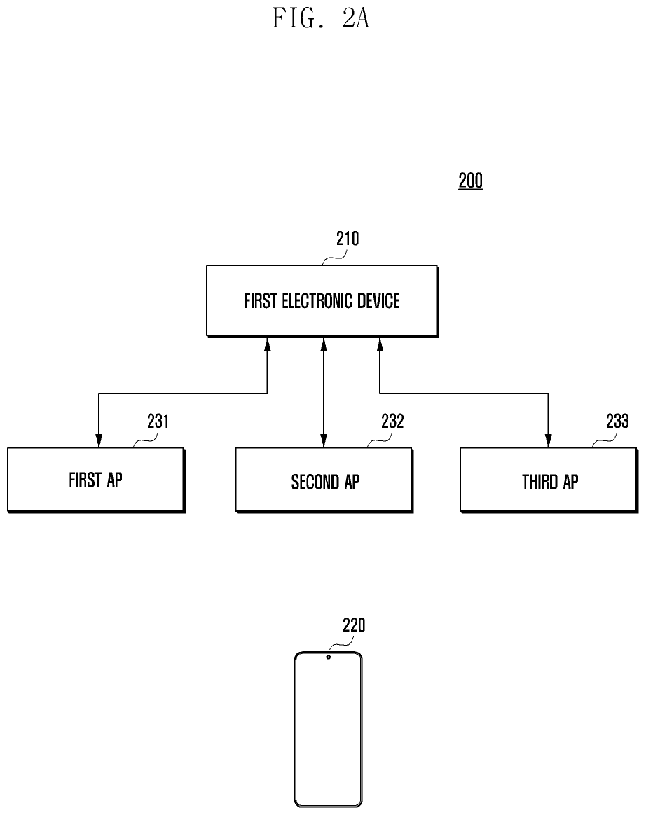

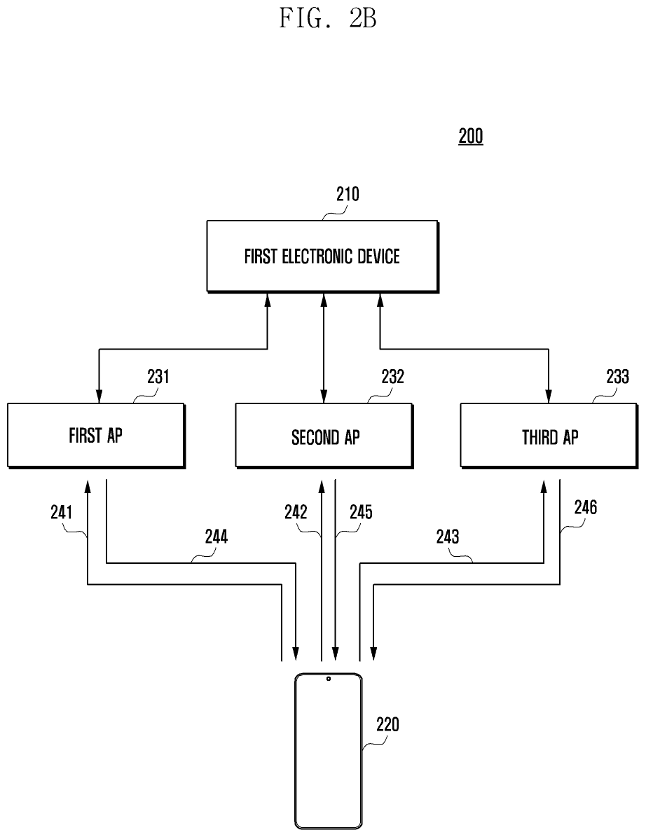

FIG. 2A is a diagram illustrating a first electronic device, at least one AP, and a second electronic device according to an embodiment.

With reference to FIG. 2A, a wireless LAN system 200 may include a first electronic device 210 and/or at least one access point (AP) (e.g., a first AP 231, a second AP 232, and a third AP 233).

The wireless LAN system 200 may provide short-range wireless communication using at least one AP 231, 232, or 233 to a second electronic device 220. The second electronic device 220 may perform the role of a station (STA) defined in IEEE 802.11. The wireless LAN system 200 may provide short-range wireless communication using a plurality of APs to the second electronic device 220. According to an embodiment, the second electronic device 220 may be connected to at least one AP of the first AP 231, the second AP 232, and/or the third AP 233, and transmit and/or receive data through the connected at least one AP. The second electronic device 220 may receive data from two or more APs and/or transmit data through two or more APs. A method of providing data transmission and/or reception through a plurality of APs may be referred to as multi-AP coordination.

The wireless LAN system 200 capable of providing multi-AP coordination may include a first electronic device 210, which is an entity capable of controlling at least one AP 231, 232, and 233. The first electronic device 210 may be connected to at least one AP 231, 232, and 233 through wired and/or wireless means to control an operation of at least one AP 231, 232, and 233.

The wireless LAN system 200 (or the first electronic device 210) capable of providing multi-AP coordination may control at least one AP 231, 232, and/or 233 to transmit and/or receive data through the same frequency band (or the same wireless channel) for efficiency in data transmission and/or reception.

At least one AP 231, 232, and 233 included in the wireless LAN system 200 may transmit data to the second electronic device 220 and/or receive data transmitted by the second electronic device 220 through the same frequency band (or the same wireless channel).

The second electronic device 220 may transmit a signal for searching for APs 231, 232, and 233 that may be connected to the second electronic device 220 in order to connect to at least one AP 231, 232, and 233. According to an embodiment, the second electronic device 220 may transmit (or broadcast) a probe request frame or a signal including a probe request frame in order to search for a connectable AP. The probe request frame may include identification information of the second electronic device 220, address information (e.g., medium access control (MAC) address) of the second electronic device 220, and performance information of the second electronic device 220 (e.g., frequency band supported by the second electronic device 220, frequency band preferred by the second electronic device 220) related to short-range wireless communication.

Among at least one AP 231, 232, and 233, the AP that has received the probe request frame transmitted by the second electronic device 220 may transmit a probe response frame, corresponding to the probe request frame received from the second electronic device 220, to the second electronic device 220. The probe response frame may include, for example, identification information of the AP, an address of the AP, and/or performance information of the AP.

The second electronic device 220 and the AP that has transmitted the probe response frame may establish (generate) a link (or wireless channel) based on information included in the probe response frame and/or information included in a probe request frame, and transmit and/or receive data through the link.

FIG. 2B is a diagram illustrating an example in which a second electronic device broadcasts a probe request frame according to an embodiment.

With reference to FIG. 2B, a wireless LAN system 200 may include a first electronic device 210 and/or at least one access point (AP) (e.g., a first AP 231, a second AP 232, a third AP 233). The wireless LAN system 200 may support a method (or multi-AP coordination) of providing data transmission and/or reception through a plurality of APs.

A second electronic device 220 may transmit a signal for searching for APs 231, 232, and 233 that may be connected to the second electronic device 220 in order to connect to at least one AP 231, 232, and 233. According to an embodiment, the second electronic device 220 may transmit (or broadcast) a probe request frame or a signal including a probe request frame in order to search for a connectable AP. The probe request frame may include identification information of the second electronic device 220, address information (e.g., MAC address) of the second electronic device 220, and performance information of the second electronic device 220 (e.g., frequency band supported by the second electronic device 220, frequency band preferred by the second electronic device 220) related to short-range wireless communication.

With reference to FIG. 2B, the second electronic device 220 may transmit (241) a probe request frame to the first AP 231, transmit (242) a probe request frame to the second AP 232, and/or transmit (243) a probe request frame to the third AP 233.

The first AP 231 may transmit (244) a probe response frame corresponding to the probe request frame (241) received from the second electronic device 220, to the second electronic device 220. The second AP 232 may transmit (245) a probe response frame corresponding to the probe request frame (242) received from the second electronic device 220, to the second electronic device 220. The third AP 233 may transmit (246) a probe response frame corresponding to the probe request frame (243) received from the second electronic device 220, to the second electronic device 220.

The wireless LAN system 200 (or the first electronic device 210) capable of providing multi-AP coordination may be configured so that at least one AP 231, 232, and/or 233 transmits and/or receives data through the same frequency band (or the same wireless channel) for efficiency in data transmission and/or reception. In the case that at least one AP 231, 232, and/or 233 transmits a probe response frame through the same frequency band (or the same wireless channel), congestion in a frequency band (or wireless channel) in which control data (e.g., probe request frame, probe response frame) and/or data are/is transmitted and/or received may increase.

In the case that the number of electronic devices transmitting probe request frames increases, in addition to the second electronic device 220, the number of times in which at least one AP 231, 232, and 233 transmits probe response frames may increase, and congestion in a frequency band (or wireless channel) in which control data (e.g., probe request frame, probe response frame) and/or data are/is transmitted and/or received may further increase.

In the case that congestion in a frequency band (or wireless channel) in which control data (e.g., probe request frame, probe response frame) and/or data are/is transmitted and/or received increases, the time required for transmission and/or reception of data may increase, and a quality of short-range wireless communication may be deteriorated.

Hereinafter, an example in which an AP transmitting a probe response frame is selected based on a quality of a signal including a probe request frame and/or a status of a buffer of the AP and in which the selected AP transmits the probe response frame to the second electronic device 220, thereby reducing (or preventing) an increase in congestion in a frequency band (or wireless channel) is described.

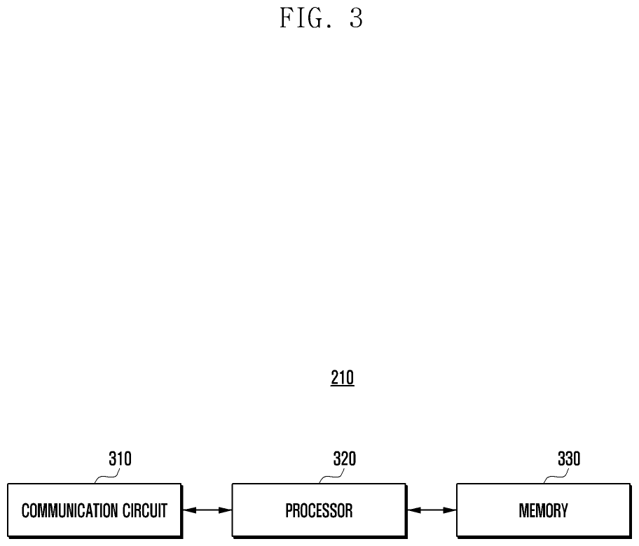

FIG. 3 is a block diagram illustrating a first electronic device according to an embodiment.

The first electronic device (e.g., the first electronic device 210 of FIG. 2A) may include a communication circuit 310 (e.g., the wireless communication module 192 of FIG. 1), a processor 320 (e.g., the processor 120 of FIG. 1), and/or a memory 330.

The communication circuit 310 may include various circuit structures used for modulating and/or demodulating signals within the electronic device 210. For example, the communication circuit 310 may modulate a baseband signal into a radio frequency (RF) band signal to output through an antenna (not illustrated) or demodulate an RF band signal received through an antenna into a baseband signal to transmit the signal to the processor 320.

The communication circuit 310 may transmit a plurality of packets to at least one AP (e.g., the first AP 231, the second AP 232, and/or the third AP 233 of FIG. 2A) or receive data transmitted by at least one AP 231, 232, and/or 233 through short-distance wireless communication or wired communication.

The processor 320 may be operatively connected to the communication circuit 310 to control an operation of the communication circuit 310. The processor 320 may perform an operation of at least one AP 231, 232, and/or 233 included in a wireless LAN system (e.g., the wireless LAN system 200 of FIG. 2A) and/or an operation of allocating resources used by at least one AP 231, 232, and/or 233. At least one AP 231, 232, and/or 233 included in the wireless LAN system 200 composed of multi-coordination may transmit and/or receive data through the same frequency band (or the same channel).

The memory 330 may store instructions that may be executed by the processor 320. Operations of the processor 320 described below may be performed by executing instructions stored on the memory 330.

The processor 320 may detect transmission of a probe request frame for searching for at least one AP, for example, at least one of AP 231, 232, and/or 233.

According to an embodiment, the second electronic device (e.g., the second electronic device 220 of FIG. 2A) may broadcast (or transmit) a probe request frame for searching for at least one AP 231, 232, and/or 233 in order to connect to at least one AP 231, 232, and/or 233. The probe request frame may include identification information of the second electronic device 220 and performance information of the second electronic device 220 related to short-range wireless communication.

Among at least one AP 231, 232, and/or 233, the AP that has received the probe request frame may transmit information related to the probe request frame to the first electronic device 210.

Information related to the probe request frame may include a quality of the probe request frame (or a signal including the probe request frame) and/or information indicating reception of the probe request frame. The quality of the probe request frame (or a signal including the probe request frame) may be measured (or identified or determined) by the AP that has received the probe request frame. The quality of the probe request frame may include strength of a signal including the probe request frame and measured by the AP that has received the probe request frame.

The quality of the probe request frame may be implemented into a received signal strength indicator (RSSI), received signal received power (RSRP), a signal to noise ratio (SNR), and a signal to interference noise ratio (SINR). Among at least one AP 231, 232, and/or 233, an AP that has received the probe request frame may transmit at least one of RSSI, RSRP, SNR, and/or SINR of the signal including the probe request frame to the first electronic device 210. Alternatively, among at least one AP 231, 232, and/or 233, an AP that has received the probe request frame may transmit a value generated based on at least one of RSSI, RSRP, SNR, and/or SINR of the signal including the probe request frame to the first electronic device 210. A value generated based on at least one of RSSI, RSRP, SNR, and/or SINR of the signal including the probe request frame may be a value related to the quality of the signal including the probe request frame.

The processor 320 may select an AP to transmit a probe response frame to the second electronic device 220 based on a quality of a signal included in information related to the probe request frame and/or a status of the AP that has received the probe request frame.

According to an embodiment, the processor 320 may identify a quality of a signal included in information related to the probe request frame and select an AP that has measured the highest quality as an AP to transmit the probe response frame to the second electronic device 220.

According to an embodiment, in the case that a quality of a signal measured by the first AP 231 is −40 dB and that a quality of a signal measured by the second AP 232 is −50 dB and that a quality of a signal measured by the third AP 233 is −60 dB, the processor 320 may select the first AP 231 that has measured the highest quality as an AP to transmit the probe response frame to the second electronic device 220.

According to an embodiment, a status of an AP that has received the probe request frame may include a size of data temporarily stored in a buffer of the AP that has received the probe request frame. The size of data temporarily stored in the buffer may refer to a size of data to be transmitted by the AP. As the size of data temporarily stored in the buffer increases, the time it takes for the AP to transmit a probe response frame may increase. Conversely, the smaller the size of data temporarily stored in the buffer, the less time it takes for the AP to transmit a probe response frame. The processor 320 may select an AP to transmit a probe response frame to the second electronic device 220 based on the size of data stored in the buffer of the AP that has received the probe request frame.

According to an embodiment, the processor 320 may select an AP having the smallest size of data stored in the buffer among at least one AP 231, 232, and/or 233 as an AP to transmit the probe response frame to the second electronic device 220.

According to an embodiment, the processor 320 may select an AP to transmit a probe response frame to the second electronic device 220 in consideration of both a quality of a signal included in information related to the probe request frame and/or a status of an AP that has received the probe request frame.

The processor 320 may select an AP to transmit the probe response frame to the second electronic device 220 using a value related to a quality of a signal (a signal including a probe request frame) measured by at least one AP 231, 232, and/or 233 and a value related to a size of data stored in a buffer of at least one AP 231, 232, and/or 233.

For example, a value related to a quality of a signal (e.g., a signal including a probe request frame) measured by at least one AP 231, 232, and/or 233 may have a larger value as the quality increases. A value related to the size of data stored in a buffer of at least one AP 231, 232, and/or 233 may have a larger value as the size of data stored in the buffer becomes smaller. The processor 320 may select an AP having the highest value among values determined using a value related to a quality of a signal (a signal including a probe request frame) measured by at least one AP 231, 232, and/or 233 and a value related to a size of data stored in a buffer of at least one AP 231, 232, and/or 233 as an AP to transmit to the second electronic device 220.

The processor 320 may identify a quality of a signal included in information related to the probe request frame and a size of data stored in a buffer of the AP that has measured the highest quality. When the processor 320 identifies that the size of data stored in the buffer of the AP that has measured the highest quality is greater than or equal to (or exceeds) a designated value (or threshold value), the processor 320 may select an AP having the smallest size of data stored in a buffer or an AP that has measured the second highest quality as an AP to transmit the probe response frame.

The processor 320 may transmit a quality of the probe request frame (or a signal including the probe request frame) measured by at least one AP 231, 232, and/or 233 and/or identification information of at least one AP 231, 232, and/or 233 to the selected AP.

The quality of the probe request frame (or a signal including the probe request frame) measured by at least one AP 231, 232, and/or 233 and/or identification information of at least one AP 231, 232, and/or 233 may be included in the probe response frame to be transmitted by the selected AP.

The quality of the probe request frame (or a signal including the probe request frame) measured by at least one AP 231, 232, and/or 233 may be used when the second electronic device 220 that has received the probe response frame selects an AP to be connected to the second electronic device 220. According to an embodiment, the second electronic device 220 may select an AP that has measured the highest signal quality among qualities of a signal included in the probe response frame and be connected to the selected AP.

The quality of the signal measured by at least one AP 231, 232, and/or 233 may be included in the probe response frame. According to an embodiment, the quality of the signal measured by at least one AP 231, 232, and/or 233 may be included in a target beacon transmission time (TBTT) information field included in a neighbor AP information field of the probe response frame.

The TBTT information field may include information on an AP adjacent to the AP that has transmitted the probe response frame. Information on the adjacent AP may include identification information of the adjacent AP and identification information of a basic service set (BSS) including the adjacent AP. The TBTT information field may include a reserve field that does not include data, and a quality of a signal measured by at least one AP 231, 232, and/or 233 may be included in a reserve field.

The TBTT information field is only one example, and the quality of the signal measured by at least one AP 231, 232, and/or 233 may be included in various fields of the probe response frame.

The processor 320 may control the selected AP to transmit a signal (or frame) including a quality of the signal measured by at least one AP 231, 232, and/or 233 to the second electronic device 220, separately from the probe response frame.

Through the method described above, the first electronic device 210 may configure any one of APs that have received the probe request frame transmitted by the second electronic device 220 to transmit a probe response frame to the second electronic device 220, thereby preventing (or reducing) an increase in congestion in a frequency band (or wireless channel) that may occur when all APs that have received the probe request frame transmitted by the second electronic device 220 transmit the probe request frame, and the speed of data transmission and/or reception may be improved by preventing an increase in frequency band congestion.

The processor 320 may omit an operation of selecting an AP to transmit a probe response frame based on a status of a channel (or link) between the second electronic device 220 and at least one AP 231, 232, and/or 233 and a status of a channel (or link) between at least one AP 231, 232, and/or 233 and the first electronic device 210. Omitting the operation of selecting an AP to transmit a probe response frame may refer to enabling all APs that have received a probe request frame to transmit a probe response frame.

According to an embodiment, the processor 320 may analyze a status of a channel (or link) between the second electronic device 220 and at least one AP 231, 232, and/or 233 and a status of a channel (or link) between at least one AP 231, 232, and/or 233 and the first electronic device 210 to determine (or calculate, predict) a difference between a time at which the probe request frame is received and a time at which the probe response frame is to be transmitted. If the processor 320 identifies that a difference between a time at which the probe request frame is received and a time at which the probe response frame is to be transmitted is greater than or equal to (or exceeds) the required maximum delay time, the processor 320 may enable all APs that have received the probe request frame to transmit the probe response frame. Alternatively, if the processor 320 identifies that a difference between a time at which the probe request frame is received and a time at which the probe response frame is to be transmitted is (or less than) the required maximum delay time or less, the processor 320 may select an AP to transmit a probe request frame among APs that have received the probe request frame and control the selected AP to transmit a probe response frame.

According to an embodiment, the processor 320 may wait for reception of information related to the probe request frame during a time period having a threshold value. The processor 320 may select an AP to transmit a probe response frame among APs that have transmitted information related to a probe request frame received during a time period having a threshold value. According to an embodiment, in the case that information related to the probe request frame is received after a time period having a threshold value, the processor 320 may control the AP that has transmitted information related to the probe request frame to transmit a probe response frame. An AP that has transmitted information related to a probe request frame received after a time period having a threshold value may transmit a probe response frame separately from the selected AP.

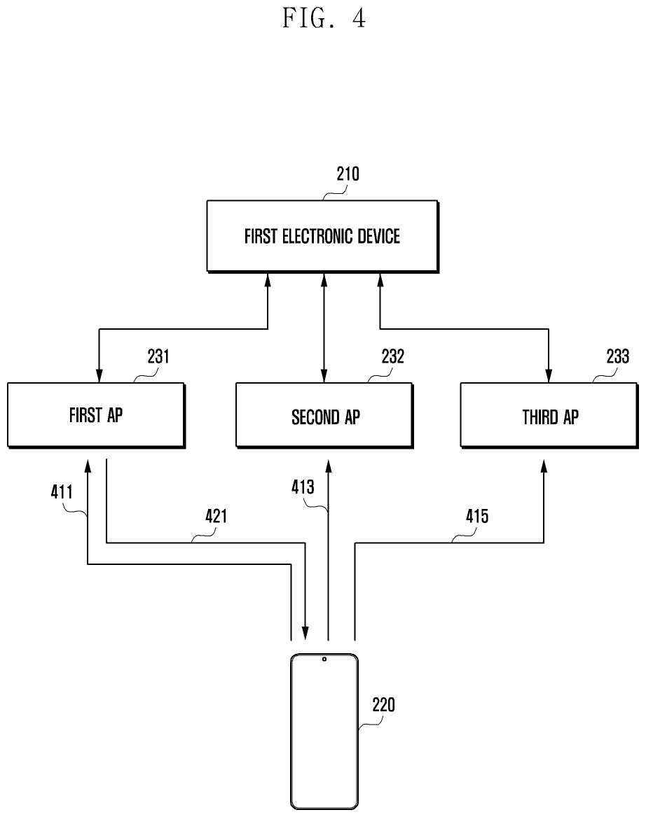

FIG. 4 is a diagram illustrating an example in which a first electronic device selects an AP to transmit a probe response frame based on a quality of a signal including a probe request frame according to an embodiment.

With reference to FIG. 4, a wireless LAN system 200 may include a first electronic device 210 and/or at least one access point (AP) (e.g., a first AP 231, a second AP 232, a third AP 233). The wireless LAN system 200 may support a method (or multi-AP coordination) of providing data transmission and/or reception through a plurality of APs.

A second electronic device 220 may transmit a signal for searching for APs 231, 232, and/or 233 that may be connected to the second electronic device 220 in order to connect to at least one AP 231, 232, and/or 233. According to an embodiment, the second electronic device 220 may transmit (or broadcast) a probe request frame or a signal including a probe request frame in order to search for a connectable AP. The probe request frame may include identification information of the second electronic device 220, address information (e.g., MAC address) of the second electronic device 220, and performance information of the second electronic device 220 (e.g., frequency band supported by the second electronic device 220, frequency band preferred by the second electronic device 220) related to short-range wireless communication.

With reference to FIG. 4, the second electronic device 220 may transmit (411) a probe request frame to the first AP 231, transmit (413) a probe request frame to the second AP 232, and/or transmit (415) a probe request frame to the third AP 233. The first AP 231, the second AP 232, and/or the third AP 233 may receive a probe request frame.

In an operation of receiving a frame request frame, the first AP 231 may measure a quality of a probe request frame or a signal including the probe request frame. The quality of the probe request frame may be implemented into a received signal strength indicator (RSSI) and received signal received power (RSRP).

The first AP 231 may transmit information related to the probe request frame, including a quality of the probe request frame or a signal including the probe request frame, to the first electronic device 210.

In an operation of receiving a probe request frame, the second AP 232 may measure a quality of the probe request frame or a signal including the probe request frame. The quality of the probe request frame may be implemented into a received signal strength indicator (RSSI) and received signal received power (RSRP).

The second AP 232 may transmit information related to the probe request frame, including a quality of the probe request frame or a signal including the probe request frame, to the first electronic device 210.

In an operation of receiving a probe request frame, the third AP 233 may measure a quality of the probe request frame or a signal including the probe request frame. The quality of the probe request frame may be implemented into a received signal strength indicator (RSSI) and received signal received power (RSRP).

The third AP 233 may transmit information related to the probe request frame, including a quality of the probe request frame or a signal including the probe request frame, to the first electronic device 210.

The first electronic device 210 may select an AP to transmit a probe response frame to the second electronic device 220 based on a quality of a signal included in information related to the probe request frame and/or a status of an AP that has received the probe request frame.

According to an embodiment, in the case that a quality of a signal measured by the first AP 231 is −40 dB and that a quality of a signal measured by the second AP 232 is −50 dB and that a quality of a signal measured by the third AP 233 is −60 dB, the first electronic device 210 may select the first AP 231 that has measured the highest quality as an AP to transmit the probe response frame to the second electronic device 220.

The first electronic device 210 may transmit a quality of the probe request frame (or a signal including the probe request frame) measured by at least one AP 231, 232, and/or 233 and/or identification information of at least one AP 231, 232, and/or 233 to the first AP 231.

The quality of the probe request frame (or a signal including the probe request frame) measured by at least one AP 231, 232, and/or 233 and/or identification information of at least one AP 231, 232, and/or 233 may be included in the probe response frame to be transmitted by the selected AP.

The quality of the probe request frame (or a signal including the probe request frame) measured by at least one AP 231, 232, and/or 233 may be used when the second electronic device 220 that has received the probe response frame selects an AP to be connected to the second electronic device 220. According to an embodiment, the second electronic device 220 may select an AP that has measured the highest signal quality among qualities of a signal included in the probe response frame and be connected to the selected AP.

The quality of the signal measured by at least one AP 231, 232, and/or 233 may be included in the probe response frame. According to an embodiment, the quality of the signal measured by at least one AP 231, 232, and/or 233 may be included in a target beacon transmission time (TBTT) information field included in a neighbor AP information field of the probe response frame.

The TBTT information field may include information on an AP adjacent to the AP that has transmitted the probe response frame. Information on the adjacent AP may include identification information of the adjacent AP and identification information of a basic service set (BSS) including the adjacent AP. The TBTT information field may include a reserve field that does not include data, and the quality of the signal measured by at least one AP 231, 232, and/or 233 may be included in a reserve field.

The TBTT information field is only one example, and the quality of the signal measured by at least one AP 231, 232, and/or 233 may be included in various fields of the probe response frame.

The first electronic device 210 may control the first AP 231 so that the first AP 231 transmits (421) a probe response frame to the second electronic device 220. Even if the second AP 232 and/or the third AP 233 receive(s) a probe request frame, the second AP 232 and/or the third AP 233 may not transmit a probe response frame. Accordingly, by not transmitting the probe response frame, the second AP 232 and/or the third AP 233 may prevent (or reduce) an increase in congestion in a frequency band (or wireless channel) used by the first AP 231, the second AP 232, and/or the third AP 233.

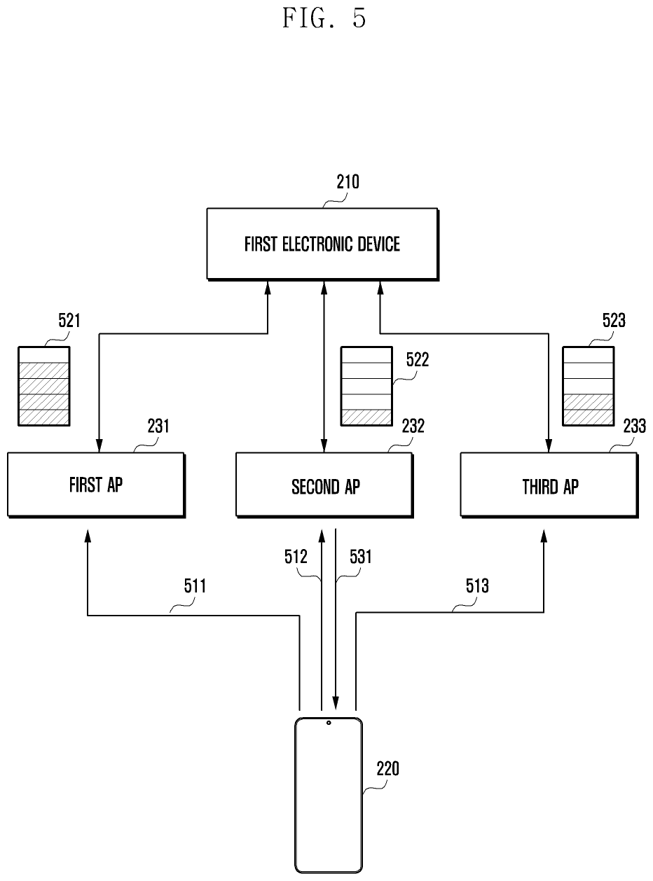

FIG. 5 is a diagram illustrating an example in which a first electronic device selects an AP to transmit a probe response frame based on a quality of a signal including a probe request frame and a status of a buffer of at least one AP according to an embodiment.

With reference to FIG. 5, a wireless LAN system 200 may include a first electronic device 210 and/or at least one access point (AP) (e.g., a first AP 231, a second AP 232, a third AP 233). The wireless LAN system 200 may support a method (or multi-AP coordination) of providing data transmission and/or reception through a plurality of APs.

A second electronic device 220 may transmit a signal for searching for APs 231, 232, and/or 233 that may be connected to the second electronic device 220 in order to connect to at least one AP 231, 232, and/or 233. According to an embodiment, the second electronic device 220 may transmit (or broadcast) a probe request frame or a signal including a probe request frame in order to search for a connectable AP. The probe request frame may include identification information of the second electronic device 220, address information (e.g., MAC address) of the second electronic device 220, and performance information of the second electronic device 220 (e.g., frequency band supported by the second electronic device 220, frequency band preferred by the second electronic device 220) related to short-range wireless communication.

With reference to FIG. 5, the second electronic device 220 may transmit (511) a probe request frame to the first AP 231, transmit (512) a probe request frame to the second AP 232, and/or transmit (513) a probe request frame to the third AP 233. The first AP 231, the second AP 232, and/or the third AP 233 may receive a probe request frame.

In an operation of receiving a probe request frame, the first AP 231 may measure a quality of the probe request frame or a signal including the probe request frame. The quality of the probe request frame may be implemented into a received signal strength indicator (RSSI), received signal received power (RSRP), a signal to noise ratio (SNR), and a signal to interference noise ratio (SINR).

The first AP 231 may transmit information related to the probe request frame, including a quality of the probe request frame or a signal including the probe request frame, to the first electronic device 210.

In an operation of receiving a probe request frame, the second AP 232 may measure a quality of the probe request frame or a signal including the probe request frame. The quality of the probe request frame may be implemented into a received signal strength indicator (RSSI), received signal received power (RSRP), a signal to noise ratio (SNR), and a signal to interference noise ratio (SINR).

The second AP 232 may transmit information related to the probe request frame, including a quality of the probe request frame or a signal including the probe request frame, to the first electronic device 210.

In an operation of receiving a probe request frame, the third AP 233 may measure a quality of the probe request frame or a signal including the probe request frame. The quality of the probe request frame may be implemented into a received signal strength indicator (RSSI) and received signal received power (RSRP).

The third AP 233 may transmit information related to the probe request frame, including a quality of the probe request frame or a signal including the probe request frame, to the first electronic device 210.

The first electronic device 210 may select an AP to transmit a probe response frame to the second electronic device 220 based on a quality of a signal included in information related to the probe request frame and/or a status of an AP that has received the probe request frame.

According to an embodiment, a status of the AP that has received the probe request frame may include a size of data temporarily stored in a buffer of the AP that has received the probe request frame. The size of data temporarily stored in the buffer may refer to a size of data to be transmitted by the AP. As the size of data temporarily stored in the buffer increases, the time it takes for the AP to transmit a probe response frame may increase. Conversely, the smaller the size of data temporarily stored in the buffer, the less time it takes for the AP to transmit a probe response frame. The first electronic device 210 may select an AP to transmit a probe response frame to the second electronic device 220 based on the size of data stored in the buffer of the AP that has received the probe request frame.

With reference to FIG. 5, the size of data stored in a buffer 521 of the first AP 231 may be larger than a size of data stored in a buffer 522 of the second AP 232 and/or a size of data stored in a buffer 523 of the third AP 233. The size of data stored in the buffer 523 of the third AP 233 may be larger than that of data stored in the buffer 522 of the second AP 232.

The first electronic device 210 may select the second AP 232, which is an AP having the smallest size of data stored in the buffer as an AP to transmit the probe response frame.

The first electronic device 210 may transmit a quality of the probe request frame (or a signal including the probe request frame) measured by at least one AP 231, 232, and/or 233 and/or identification information of at least one AP 231, 232, and/or 233 to the second AP 232.

The quality of the probe request frame (or a signal including the probe request frame) measured by at least one AP 231, 232, and/or 233 and/or identification information of at least one AP 231, 232, and/or 233 may be included in the probe response frame to be transmitted by the selected AP.

The quality of the probe request frame (or a signal including the probe request frame) measured by at least one AP 231, 232, and/or 233 may be used when the second electronic device 220 that has received the probe response frame selects an AP to be connected to the second electronic device 220. According to an embodiment, the second electronic device 220 may select an AP that has measured the highest signal quality among qualities of a signal included in the probe response frame and be connected to the selected AP.

The quality of the signal measured by at least one AP 231, 232, and/or 233 may be included in the probe response frame. According to an embodiment, the quality of the signal measured by at least one AP 231, 232, and/or 233 may be included in a target beacon transmission time (TBTT) information field included in a neighbor AP information field of the probe response frame.

The TBTT information field may include information on an AP adjacent to an AP that has transmitted the probe response frame. Information on the adjacent AP may include identification information of the adjacent AP and identification information of a basic service set (BSS) including the adjacent AP. The TBTT information field may include a reserve field that does not include data, and the quality of the signal measured by at least one AP 231, 232, and/or 233 may be included in a reserve field.

The TBTT information field is only one example, and the quality of the signal measured by at least one AP 231, 232, and/or 233 may be included in various fields of the probe response frame.

The first electronic device 210 may control the second AP 232 so that the second AP 232 transmits a probe response frame to the second electronic device 220. Even if the first AP 231 and/or the third AP 233 receive(s) a probe request frame, the first AP 231 and/or the third AP 233 may not transmit a probe response frame. Accordingly, by not transmitting the probe response frame, the first AP 231 and/or the third AP 233 may prevent (or reduce) an increase in congestion in a frequency band (or wireless channel) used by the first AP 231, the second AP 232, and/or the third AP 233.

FIG. 5 describes that the status of the AP that has received the probe request frame includes a size of data temporarily stored in the buffer of the AP that has received the probe request frame, but the disclosure may not be limited thereto.

The status of the AP that has received the probe request frame may include information related to the size of data temporarily stored in the buffer of the AP that has received the probe request frame. Information related to the size of data temporarily stored in the buffer of the AP that has received the probe request frame may include various information that may be generated based on the size of data. According to an embodiment, information related to the size of data temporarily stored in the buffer of the AP that has received the probe request frame may include a time required for the AP to transmit data to an STA (e.g., the second electronic device 220). The time required to transmit data may be generated (or determined) by multiplying a data size and a data transmission rate. The first electronic device 210 may select an AP to transmit a probe response frame based on information related to the size of data temporarily stored in the buffer of the AP and transmitted by at least one AP 231, 232, and/or 233. According to an embodiment, the first electronic device 210 may control an AP that takes the least time to transmit data to transmit a probe response frame to the second electronic device 220.

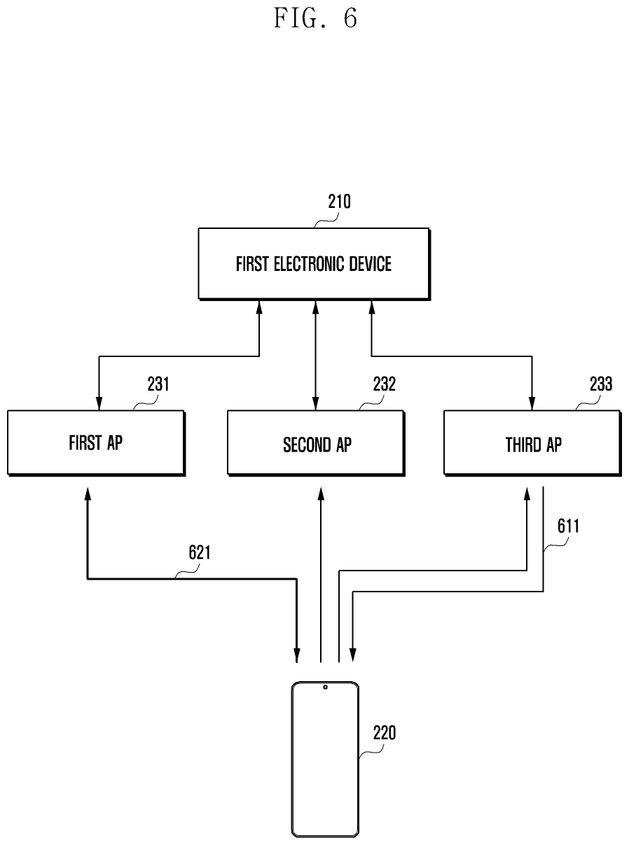

FIG. 6 is a diagram illustrating an example in which a first electronic device controls a selected AP to transmit a probe response frame according to an embodiment.

With reference to FIG. 6, a wireless LAN system 200 may include a first electronic device 210 and/or at least one access point (AP) (e.g., a first AP 231, a second AP 232, a third AP 233). The wireless LAN system 200 may support a method (or multi-AP coordination) of providing data transmission and/or reception through a plurality of APs.

A second electronic device 220 may transmit a signal for searching for APs 231, 232, and/or 233 that may be connected to the second electronic device 220 in order to connect to at least one AP 231, 232, and/or 233. According to an embodiment, the second electronic device 220 may transmit (or broadcast) a probe request frame or a signal including a probe request frame in order to search for a connectable AP. The probe request frame may include identification information of the second electronic device 220, address information (e.g., MAC address) of the second electronic device 220, and performance information of the second electronic device 220 (e.g., frequency band supported by the second electronic device 220, frequency band preferred by the second electronic device 220) related to short-range wireless communication.

With reference to FIG. 6, the second electronic device 220 may transmit a probe request frame to the first AP 231, transmit a probe request frame to the second AP 232, and/or transmit a probe request frame to the third AP 233. The first AP 231, the second AP 232, and/or the third AP 233 may receive a probe request frame.

In an operation of receiving a probe request frame, the first AP 231 may measure a quality of the probe request frame or a signal including the probe request frame. The quality of the probe request frame may be implemented into a received signal strength indicator (RSSI) and received signal received power (RSRP).

The first AP 231 may transmit information related to the probe request frame, including a quality of the probe request frame or a signal including the probe request frame, to the first electronic device 210.

In an operation of receiving a probe request frame, the second AP 232 may measure a quality of the probe request frame or a signal including the probe request frame. The quality of the probe request frame may be implemented into a received signal strength indicator (RSSI), received signal received power (RSRP), a signal to noise ratio (SNR), and a signal to interference noise ratio (SINR).

The second AP 232 may transmit information related to the probe request frame, including a quality of the probe request frame or a signal including the probe request frame, to the first electronic device 210.

In an operation of receiving a probe request frame, the third AP 233 may measure a quality of the probe request frame or a signal including the probe request frame. The quality of the probe request frame may be implemented into a received signal strength indicator (RSSI), received signal received power (RSRP), a signal to noise ratio (SNR), and a signal to interference noise ratio (SINR).

The third AP 233 may transmit information related to the probe request frame, including a quality of the probe request frame or a signal including the probe request frame, to the first electronic device 210.

The first electronic device 210 may select an AP to transmit a probe response frame to the second electronic device 220 based on a quality of the signal included in information related to the probe request frame and/or a status of the AP that has received the probe request frame.

According to an embodiment, the status of the AP that has received the probe request frame may include a size of data temporarily stored in a buffer of the AP that has received the probe request frame. The size of data temporarily stored in the buffer may refer to a size of data to be transmitted by the AP. As the size of data temporarily stored in the buffer increases, the time it takes for the AP to transmit a probe response frame may increase. Conversely, the smaller the size of data temporarily stored in the buffer, the less time it takes for the AP to transmit a probe response frame. The first electronic device 210 may select an AP to transmit a probe response frame to the second electronic device 220 based on the size of data stored in the buffer of the AP that has received the probe request frame.

In FIG. 6, for convenience of description, it is assumed that the first electronic device 210 selects the third AP 233 as an AP to transmit the probe response frame.

The first electronic device 210 may transmit a quality of the probe request frame (or a signal including the probe request frame) measured by at least one AP 231, 232, and/or 233 and/or identification information of at least one AP 231, 232, and/or 233 to the third AP 233.

The quality of the probe request frame (or a signal including the probe request frame) measured by at least one AP 231, 232, and/or 233 and/or identification information of at least one AP 231, 232, and/or 233 may be included in the probe response frame to be transmitted by the selected AP.

The quality of the probe request frame (or a signal including the probe request frame) measured by at least one AP 231, 232, and/or 233 may be used when the second electronic device 220 that has received the probe response frame selects an AP to be connected to the second electronic device 220. According to an embodiment, the second electronic device 220 may select an AP (e.g., the first AP 231) that has measured the highest signal quality among qualities of a signal included in the probe response frame, and be connected to the selected AP (e.g., the first AP 231).

The quality of the signal measured by at least one AP 231, 232, and/or 233 may be included in the probe response frame. According to an embodiment, the quality of the signal measured by at least one AP 231, 232, and/or 233 may be included in a target beacon transmission time (TBTT) information field included in a neighbor AP information field of the probe response frame.

The TBTT information field may include information on an AP adjacent to the AP that has transmitted the probe response frame. Information on the adjacent AP may include identification information of the adjacent AP and identification information of a basic service set (BSS) including the adjacent AP. The TBTT information field may include a reserve field that does not include data, and the quality of the signal measured by at least one AP 231, 232, and/or 233 may be included in a reserve field.

The TBTT information field is only one example, and the quality of the signal measured by at least one AP 231, 232, and/or 233 may be included in various fields of the probe response frame.

The first electronic device 210 may control the third AP 233 to transmit (611) a probe response frame to the second electronic device 220.

The second electronic device 220 may receive the probe response frame and identify a quality of a signal measured by each of the at least one AP 231, 232, and/or 233 included in the probe response frame. The second electronic device 220 may select an AP (e.g., the first AP 231) that has measured the highest quality as an AP to be connected, and perform connection (621) with the first AP 231. The AP (e.g., the third AP 233) that has transmitted the probe response frame and the AP (e.g., the first AP 231) connected to the second electronic device 220 may be different from each other.

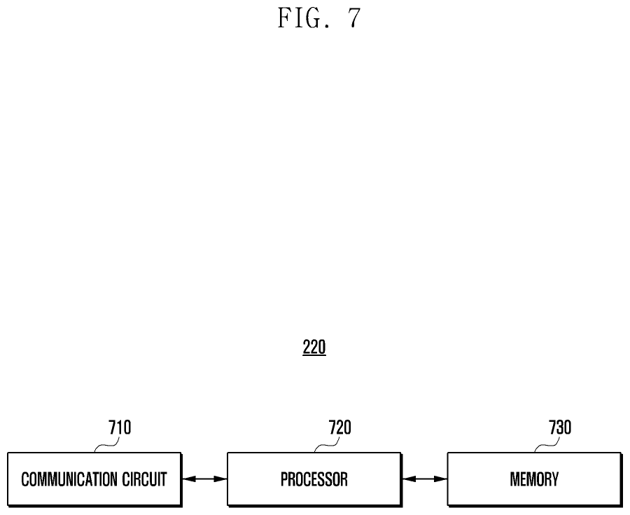

FIG. 7 is a block diagram illustrating a second electronic device according to an embodiment.

According to an embodiment, the second electronic device (e.g., the second electronic device 220 of FIG. 2A) may include a communication circuit 710 (e.g., the wireless communication module 192 of FIG. 1), a processor 720 (e.g., the processor 120 of FIG. 1), and/or a memory 730 (e.g., the memory 130 of FIG. 1).

The communication circuit 710 may include various circuit structures used for modulating and/or demodulating signals within the second electronic device 220. For example, the communication circuit 710 may modulate a baseband signal into a RF (radio frequency) band signal so as to output through an antenna (not illustrated) or demodulate an RF band signal received through an antenna into a baseband signal to transmit the signal to the processor 720.

The communication circuit 710 may perform an operation of receiving a signal transmitted by an external electronic device based on the control of the processor 720. The communication circuit 710 may control components (e.g., low-noise amplifier, switch, and/or filter) of the communication circuit 710 so as to receive a signal requesting transmission and/or reception of data through a specific channel from the processor 720, and to receive a signal through a frequency band corresponding to a specific channel.

The processor 720 may perform an operation of receiving data transmitted by an application processor (e.g., the processor 120 of FIG. 1) and generating a packet for transmitting the received data to an external electronic device. The processor 720 may be defined as a communication processor (or communication processor) included in a communication module (e.g., the wireless communication module 192 of FIG. 1). According to an embodiment, the processor 720 may generate a packet by performing channel coding based on data transmitted by the application processor 120 or identify whether at least a portion of data transmitted by the external electronic device has an error, or perform an operation of recovering an error (e.g., hybrid auto repeat request (HARQ)) in the case that an error occurs.

The processor 720 may be operatively connected to the communication circuit 710 to control an operation of the communication circuit 710.

The memory 730 may store instructions that may be executed by the processor 720. Operations of the processor 720 described below may be performed by executing instructions stored in the memory 730.

The processor 720 may control the communication circuit 710 to broadcast (or transmit) a probe request frame for searching for at least one AP (e.g., the first AP 231, the second AP 232, and/or the third AP 233 of FIG. 2A) to be connected to the second electronic device 220 in order to perform short-range wireless communication.

The probe request frame may include identification information of the second electronic device 220, address information (e.g., MAC address) of the second electronic device 220, and performance information of the second electronic device 220 (e.g., frequency band supported by the second electronic device 220, frequency band preferred by the second electronic device 220) related to short-range wireless communication.

The AP (e.g., the first AP 231, the second AP 232, and/or the third AP 233) that has received the probe request frame may measure a quality of the probe request frame or a signal including the probe request frame and transmit information related to the probe request frame including a quality to the first electronic device 210. The first electronic device 321 may select an AP to transmit a probe response frame based on information related to the probe request frame and/or a status of at least one AP 231, 232, and/or 233, and control the selected AP to transmit the probe response frame.

The quality of the probe request frame (or a signal including the probe request frame) measured by at least one AP 231, 232, and/or 233 and/or identification information of at least one AP 231, 232, and/or 233 may be included in a probe response frame to be transmitted by the selected AP.

The quality of the probe request frame (or a signal including the probe request frame) measured by at least one AP 231, 232, and/or 233 may be used when the second electronic device 220 that has received the probe response frame selects an AP to be connected to the second electronic device 220. According to an embodiment, the second electronic device 220 may select an AP that has measured the highest signal quality among qualities of a signal included in the probe response frame and be connected to the selected AP.

The quality of the signal measured by at least one AP 231, 232, and/or 233 may be included in the probe response frame. According to an embodiment, the quality of the signal measured by at least one AP 231, 232, and/or 233 may be included in a target beacon transmission time (TBTT) information field included in a neighbor AP information field of the probe response frame.

The TBTT information field may include information on an AP adjacent to an AP that has transmitted the probe response frame. Information on the adjacent AP may include identification information of the adjacent AP and identification information of a basic service set (BSS) including the adjacent AP. The TBTT information field may include a reserve field that does not include data, and the quality of the signal measured by at least one AP 231, 232, and/or 233 may be included in a reserve field.

The TBTT information field is only one example, and the quality of the signal measured by at least one AP 231, 232, and/or 233 may be included in various fields of the probe response frame.

The processor 720 may receive the probe response frame and identify a quality of the signal measured by each of the at least one AP 231, 232, and/or 233 included in the probe response frame. The processor 720 may select an AP that has measured the highest quality as an AP to be connected, and perform connection (621) with the selected AP. The AP that has transmitted the probe response frame and the AP connected to the second electronic device 220 may be different from each other.

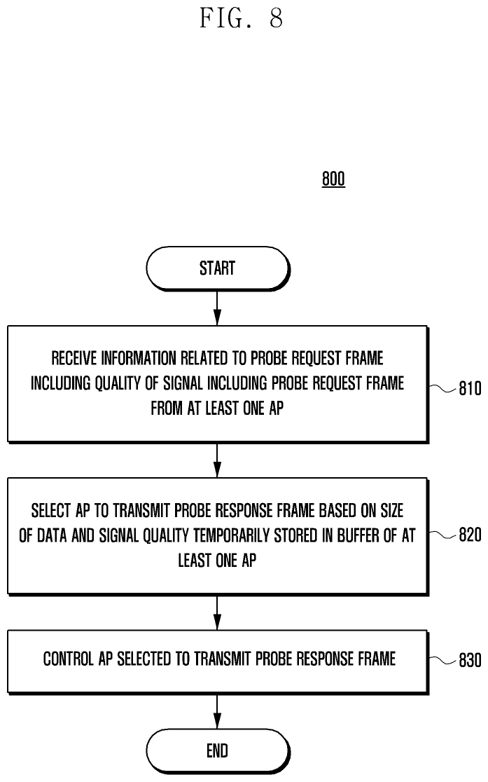

FIG. 8 is a flowchart illustrating a method 800 of operating an electronic device according to an embodiment.

In operation 810, the first electronic device (e.g., the first electronic device 210 of FIG. 3) may receive information related to a probe request frame including a quality of a signal including the probe request frame from at least one AP (e.g., the first AP 231, the second AP 232, and the third AP 233 of FIG. 2A).

According to an embodiment, the second electronic device (e.g., the second electronic device 220 of FIG. 2A) may broadcast (or transmit) a probe request frame for searching at least one AP 231, 232, and/or 233 in order to connect to at least one AP 231, 232, and/or 233. The probe request frame may include identification information of the second electronic device 220 and performance information of the second electronic device 220 related to short-range wireless communication.

Among at least one AP 231, 232, and/or 233, the AP that has received the probe request frame may transmit information related to the probe request frame to the first electronic device 210.

Information related to the probe request frame may include a quality of the probe request frame (or a signal including the probe request frame) and/or information indicating reception of the probe request frame. The quality of the probe request frame (or a signal including the probe request frame) may be measured (or identified or determined) by the AP that has received the probe request frame. The quality of the probe request frame may include strength of a signal including the probe request frame measured by the AP that has received the probe request frame.

The quality of the probe request frame may be implemented into a received signal strength indicator (RSSI), received signal received power (RSRP), a signal to noise ratio (SNR), and a signal to interference noise ratio (SINR). Among at least one AP 231, 232, and/or 233, the AP that has received the probe request frame may transmit at least one of RSSI, RSRP, SNR, and/or SINR of the signal including the probe request frame to the first electronic device 210. Alternatively, among at least one AP 231, 232, and/or 233, the AP that has received the probe request frame may transmit a value generated based on at least one of RSSI, RSRP, SNR, and/or SINR of the signal including the probe request frame to the first electronic device 210. The value generated based on at least one of RSSI, RSRP, SNR, and/or SINR of the signal including the probe request frame may be a value related to the quality of the signal including the probe request frame.

In operation 820, the first electronic device 210 may select an AP to transmit a probe response frame based on a size of data and a signal quality temporarily stored in a buffer of at least one AP.

According to an embodiment, the first electronic device 210 may identify a quality of a signal included in information related to the probe request frame and select an AP that has measured the highest quality as an AP to transmit a probe response frame to the second electronic device 220.

According to an embodiment, in the case that a quality of a signal measured by the first AP 231 is −40 dB and that a quality of a signal measured by the second AP 232 is −50 dB and that a quality of the signal measured by the third AP 233 is −60 dB, the first electronic device 210 may select the first AP 231 that has measured the highest quality as an AP to transmit the probe response frame to the second electronic device 220.

According to an embodiment, the status of the AP that has received the probe request frame may include a size of data temporarily stored in the buffer of the AP that has received the probe request frame. The size of data temporarily stored in the buffer may refer to a size of data to be transmitted by the AP. As the size of data temporarily stored in the buffer increases, the time it takes for the AP to transmit a probe response frame may increase. Conversely, the smaller the size of data temporarily stored in the buffer, the less time it takes for the AP to transmit a probe response frame. The first electronic device 210 may select an AP to transmit a probe response frame to the second electronic device 220 based on the size of data stored in the buffer of the AP that has received the probe request frame.

According to an embodiment, the first electronic device 210 may select an AP having the smallest size of data stored in the buffer among at least one AP 231, 232, and/or 233 as an AP to transmit a probe response frame to the second electronic device 220.

According to an embodiment, the first electronic device 210 may select an AP to transmit a probe response frame to the second electronic device 220 in consideration of both a quality of the signal included in information related to the probe request frame and/or a status of the AP that has received the probe request frame.

The first electronic device 210 may select an AP to transmit the probe response frame to the second electronic device 220 using a value related to a quality of a signal (a signal including a probe request frame) measured by at least one AP 231, 232, and/or 233 and a value related to a size of data stored in the buffer of at least one AP 231, 232, and/or 233.

For example, a value related to a quality of a signal (a signal including a probe request frame) measured by at least one AP 231, 232, and/or 233 may have a larger value as the quality increases. A value related to the size of data stored in the buffer of at least one AP 231, 232, and/or 233 may have a larger value as the size of data stored in the buffer becomes smaller. The first electronic device 210 may select an AP having the highest value among values determined using a value related to the quality of a signal (a signal including a probe request frame) measured by at least one AP 231, 232, and/or 233 and a value related to a size of data stored in the buffer of at least one AP 231, 232, and/or 233 as an AP to transmit to the second electronic device 220.

The first electronic device 210 may identify a quality of a signal included in information related to the probe request frame and a size of data stored in the buffer of the AP that has measured the highest quality. When the first electronic device 210 identifies that a size of data stored in the buffer of the AP that has measured the highest quality is greater than or equal to (or exceeds) a designated value (or threshold value), the first electronic device 210 may select an AP that has measured the second highest quality or an AP having the smallest size of data stored in the buffer as an AP to transmit the probe response frame.

The first electronic device 210 may transmit a quality of the probe request frame (or a signal including the probe request frame) measured by at least one AP 231, 232, and/or 233 and/or identification information of at least one AP 231, 232, and/or 233 to the selected AP.

The quality of the probe request frame (or a signal including the probe request frame) measured by at least one AP 231, 232, and/or 233 and/or identification information of at least one AP 231, 232, and/or 233 may be included in a probe response frame to be transmitted by the selected AP.

The quality of the probe request frame (or a signal including the probe request frame) measured by at least one AP 231, 232, and/or 233 may be used when the second electronic device 220 that has received the probe response frame selects an AP to be connected to the second electronic device 220. According to an embodiment, the second electronic device 220 may select an AP that has measured the highest signal quality among qualities of a signal included in the probe response frame and be connected to the selected AP.

The quality of the signal measured by at least one AP 231, 232, and/or 233 may be included in the probe response frame. According to an embodiment, the quality of the signal measured by at least one AP 231, 232, and/or 233 may be included in a target beacon transmission time (TBTT) information field included in a neighbor AP information field of the probe response frame.

The TBTT information field may include information on an AP adjacent to an AP that has transmitted the probe response frame. Information on the adjacent AP may include identification information of the adjacent AP and identification information of a basic service set (BSS) including the adjacent AP. The TBTT information field may include a reserve field that does not include data, and the quality of the signal measured by at least one AP 231, 232, and/or 233 may be included in a reserve field.

The TBTT information field is only one example, and the quality of the signal measured by at least one AP 231, 232, and/or 233 may be included in various fields of the probe response frame.

In operation 830, the first electronic device 210 may control a selected AP to transmit a probe response frame.

Through the method described above, the first electronic device 210 may configure any one of APs that have received the probe request frame transmitted by the second electronic device 220 to transmit a probe response frame to the second electronic device 220, thereby preventing (or reducing) an increase in congestion in a frequency band (or wireless channel) that may occur when all APs that have received the probe request frame transmitted by the second electronic device 220 transmit probe response frames, and the speed of data transmission and/or reception may be improved by preventing an increase in frequency band congestion.

The first electronic device 210 may control a selected AP to transmit a signal (or frame) including a quality of a signal measured by at least one AP 231, 232, and/or 233 to the second electronic device 220, separately from the probe response frame.

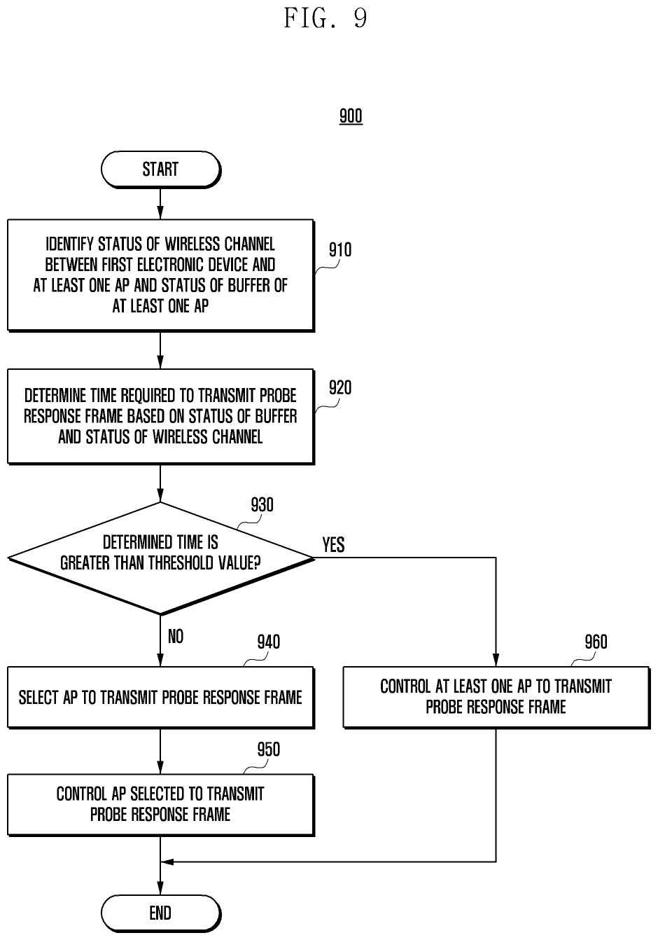

FIG. 9 is a flowchart illustrating a method 900 of operating an electronic device according to an embodiment.

With reference to FIG. 9, in operation 910, a first electronic device (e.g., the first electronic device 210 of FIG. 3) may identify a status of a wireless channel between the first electronic device 210 and at least one AP (e.g., the first AP 231, the second AP 232, and/or the third AP 233 of FIG. 2A) and a status of a buffer of at least one AP 231, 232, and/or 233.

The status of the wireless channel between the first electronic device 210 and at least one AP 231, 232, and/or 233 may be used for determining a time required to exchange specific data (e.g., information related to a probe request frame) through the wireless channel.

The status of the buffer of at least one AP 231, 232, and/or 233 may include a size of data stored in the buffer. The size of data stored in the buffer may be used for determining the time it takes for at least one AP 231, 232, and/or 233 to transmit a probe response frame.

In operation 920, the first electronic device 210 may determine a time required to transmit the probe response frame based on the status of the buffer and the status of the wireless channel.

The time required to transmit the probe response frame may include a time required for at least one AP 231, 232, and/or 233 to transmit information related to the probe request frame to the first electronic device 210, a time taken to select an AP to transmit a probe response frame based on information related to the probe request frame, a time taken to transmit information related to the probe request frame to the selected AP, and a time taken for the selected AP to transmit a probe response frame.

In operation 930, the first electronic device 210 may identify whether the determined time is greater than a threshold value (or designated time).

The threshold value (or designated time) may be a maximum delay time required in relation to transmission of the probe response frame or a value related to the maximum delay time.

A situation in which a determined time is greater than a threshold value (or designated time) may refer to a situation in which a time required for the selected AP to transmit a probe response frame is greater than the maximum delay time. In the case that a time required for the selected AP to transmit a probe response frame is greater than the maximum delay time, it may be difficult for the second electronic device 220 to perform a service through short-range wireless communication.

A situation in which a determined time is smaller than a threshold value (or designated time) may refer to a situation in which a time required for the selected AP to transmit a probe response frame is smaller than the maximum delay time. In the case that a time required for the selected AP to transmit a probe response frame is smaller than the maximum delay time, the second electronic device 220 may not significantly affect a quality of service through short-range wireless communication.

In operation 940, in the case that the determined time is smaller than a threshold value (or designated time) (operation 930-N), the first electronic device 210 may select an AP to transmit a probe response frame.

According to an embodiment, the first electronic device 210 may identify a quality of a signal included in information related to the probe request frame and select an AP that has measured the highest quality as an AP to transmit a probe response frame to the second electronic device 220.

According to an embodiment, in the case that a quality of a signal measured by the first AP 231 is −40 dB and that a quality of a signal measured by the second AP 232 is −50 dB and that a quality of a signal measured by the third AP 233 is −60 dB, the first electronic device 210 may select the first AP 231 that has measured the highest quality as an AP to transmit a probe response frame to the second electronic device 220.

According to an embodiment, a status of the AP that has received the probe request frame may include a size of data temporarily stored in a buffer of the AP that has received the probe request frame. The size of data temporarily stored in the buffer may refer to a size of data to be transmitted by the AP. As the size of data temporarily stored in the buffer increases, the time it takes for the AP to transmit a probe response frame may increase. Conversely, the smaller the size of data temporarily stored in the buffer, the less time it takes for the AP to transmit a probe response frame. The first electronic device 210 may select an AP to transmit a probe response frame to the second electronic device 220 based on the size of data stored in the buffer of the AP that has received the probe request frame.

According to an embodiment, the first electronic device 210 may select an AP having the smallest data size stored in the buffer among at least one AP 231, 232, and/or 233 as an AP to transmit a probe response frame to the second electronic device 220.

According to an embodiment, the first electronic device 210 may select an AP to transmit a probe response frame to the second electronic device 220 in consideration of both a quality of a signal included in information related to the probe request frame and/or a status of the AP that has received the probe request frame.

The first electronic device 210 may select an AP to transmit the probe response frame to the second electronic device 220 using a value related to a quality of a signal (a signal including a probe request frame) measured by at least one AP 231, 232, and/or 233 and a value related to a size of data stored in a buffer of at least one AP 231, 232, and/or 233.

For example, a value related to the quality of a signal (a signal including a probe request frame) measured by at least one AP 231, 232, and/or 233 may have a larger value as the quality increases. A value related to the size of data stored in the buffer of at least one AP 231, 232, and/or 233 may have a larger value as the size of data stored in the buffer becomes smaller. The first electronic device 210 may select an AP having the highest value among values determined using a value related to the quality of a signal (a signal including a probe request frame) measured by at least one AP 231, 232, and/or 233 and a value related to the size of data stored in the buffer of at least one AP 231, 232, and/or 233 as an AP to transmit a probe response frame to the second electronic device 220.

The first electronic device 210 may identify a quality of the signal included in information related to the probe request frame and a size of data stored in the buffer of the AP that has measured the highest quality. When the first electronic device 210 identifies that a size of data stored in the buffer of the AP that has measured the highest quality is greater than or equal to (or exceeds) a designated value (or threshold value), the first electronic device 210 may select an AP that has measured the second highest quality or an AP having the smallest size of data stored in the buffer as an AP to transmit the probe response frame.

According to an embodiment, the first electronic device 210 may wait to receive information related to the probe request frame during a time period having a threshold value. The first electronic device 210 may select an AP to transmit a probe response frame among APs that have transmitted information related to a probe request frame received during a time period having a threshold value. According to an embodiment, in the case that information related to the probe request frame is received after a time period having a threshold value, the first electronic device 210 may control an AP that has transmitted information related to the probe request frame to transmit a probe response frame. An AP that has transmitted information related to a probe request frame received after a time having a threshold value may transmit a probe response frame separately from the selected AP.

The first electronic device 210 may transmit a quality of the probe request frame (or a signal including the probe request frame) measured by at least one AP 231, 232, and/or 233 and/or identification information of at least one AP 231, 232, and/or 233 to the selected AP.

The quality of the probe request frame (or a signal including the probe request frame) measured by at least one AP 231, 232, and/or 233 and/or identification information of at least one AP 231, 232, and/or 233 may be included in a probe response frame to be transmitted by the selected AP.

The quality of the probe request frame (or a signal including the probe request frame) measured by at least one AP 231, 232, and/or 233 may be used when the second electronic device 220 that has received the probe response frame selects an AP to be connected to the second electronic device 220. According to an embodiment, the second electronic device 220 may select an AP that has measured the highest signal quality among qualities of a signal included in the probe response frame and be connected to the selected AP.

The quality of the signal measured by at least one AP 231, 232, and/or 233 may be included in the probe response frame. According to an embodiment, the quality of the signal measured by at least one AP 231, 232, and/or 233 may be included in a target beacon transmission time (TBTT) information field included in a neighbor AP information field of the probe response frame.

The TBTT information field may include information on an AP adjacent to the AP that has transmitted the probe response frame. Information on an adjacent AP may include identification information of the adjacent AP and identification information of a basic service set (BSS) including the adjacent AP. The TBTT information field may include a reserve field that does not include data, and the quality of the signal measured by at least one AP 231, 232, and/or 233 may be included in a reserve field.

The TBTT information field is only one example, and the quality of the signal measured by at least one AP 231, 232, and/or 233 may be included in various fields of the probe response frame.

In operation 950, the first electronic device 210 may control a selected AP to transmit a probe response frame.

In operation 960, in the case that the determined time is greater than a threshold value (or designated time) (operation 930-Y), the first electronic device 210 may enable at least one AP that has received the probe request frame to transmit a probe response frame.

A situation in which a determined time is greater than a threshold value (or designated time) may refer to a situation in which a time required for the selected AP to transmit a probe response frame is greater than the maximum delay time. In the case that a time required for the selected AP to transmit a probe response frame is greater than the maximum delay time, it may be difficult for the second electronic device 220 to perform a service through short-range wireless communication. Accordingly, the first electronic device 210 may configure all APs that have received a probe request frame to transmit a probe response frame, thereby omitting an operation of selecting an AP to transmit a probe response frame based on a time required to exchange information related to the probe request frame and/or information related to the probe request frame.

An electronic device according to an embodiment may include a communication circuit 310. The electronic device may include a processor 320. The electronic device may include a memory 330. The memory 330 may store, when executed by the processor 320, instructions that cause the electronic device to receive information related to a probe request frame including a quality of a signal including the probe request frame from each of at least one access point (AP) 231, 232, and/or 233 that has received the probe request frame transmitted by an external electronic device 220. The memory 330 may store instructions that cause the electronic device to select APs 231, 232, and/or 233 to transmit a probe response frame to the external electronic device 220 based on a quality of the signal and a size of data temporarily stored in buffers 521, 522, and 523 of the at least one AP 231, 232, and/or 233. The memory 330 may store instructions that cause the electronic device to control the selected APs 231, 232, and/or 233 so that the selected APs 231, 232, and/or 233 transmit the probe response frame to the external electronic device 220.

In the electronic device according to an embodiment, the memory 330 may further store instructions that cause the electronic device to select APs 231, 232, and/or 233 that have received a signal having the highest quality as APs 231, 232, and/or 233 to transmit the probe response frame.

In the electronic device according to an embodiment, in the case that a size of data stored in buffers 521, 522, and 523 of APs 231, 232, and/or 233 that have received a signal having the highest quality is greater than or equal to a designated size, the memory 330 may further store instructions that cause the electronic device to select APs 231, 232, and/or 233 having the smallest size of data stored in buffers 521, 522, and 523 as APs 231, 232, and/or 233 to transmit the probe response frame.

In the electronic device according to an embodiment, the memory 330 may further store instructions that cause the electronic device to select APs 231, 232, and/or 233 having the smallest size of data stored in buffers 521, 522, and 523 as APs 231, 232, and/or 233 to transmit the probe response frame.

In the electronic device according to an embodiment, the memory 330 may further store instructions that cause the electronic device to transmit a quality of a signal measured by the at least one AP 231, 232, and/or 233 and identification information of the at least one AP 231, 232, and/or 233 to the selected APs 231, 232, and/or 233.

In the electronic device according to an embodiment, the memory 330 may further store instructions that cause the electronic device to control the selected APs 231, 232, and/or 233 to transmit a probe response frame including a quality of the signal measured by the at least one AP 231, 232, and/or 233 and identification information of the at least one AP 231, 232, and/or 233 to the external electronic device 220.

In the electronic device according to an embodiment, the quality of the signal measured by the at least one AP 231, 232, and/or 233 may be included in a target beacon transmission time (TBTT) information field of the probe response frame.

In the electronic device according to an embodiment, the memory 330 may further store instructions that cause the electronic device to control the selected APs 231, 232, and/or 233 to transmit a signal including the probe response frame and the quality of the signal measured by the at least one AP 231, 232, and/or 233 to the external electronic device 220.

In the electronic device according to an embodiment, the at least one AP 231, 232, and/or 233 may be configured to transmit data and/or the probe response frame to the external electronic device 220 through the same channel.

In the electronic device according to an embodiment, the memory 330 may further store instructions that cause the electronic device to determine whether the at least one AP 231, 232, and/or 233 is to transmit the probe response frame based on a status of a link between the external electronic device 220 and the at least one AP 231, 232, and/or 233 and a status of a link between the electronic device and the at least one AP.

A method of operating an electronic device according to an embodiment may include receiving information related to a probe request frame including a quality of a signal including the probe request frame from each of at least one access point (AP) 231, 232, and/or 233 that has received a probe request frame transmitted by an external electronic device 220. The method of operating an electronic device may include selecting APs 231, 232, and/or 233 to transmit a probe response frame to the external electronic device 220 based on a quality of the signal and a size of data temporarily stored in buffers 521, 522, and 523 of the at least one AP 231, 232, and/or 233. The method of operating an electronic device may include controlling the selected APs 231, 232, and/or 233 so that the selected APs 231, 232, and/or 233 transmit the probe response frame to the external electronic device 220.

In a method of operating an electronic device according to an embodiment, selecting the APs 231, 232, and/or 233 may include selecting APs 231, 232, and/or 233 that have received a signal having the highest quality as APs 231, 232, and/or 233 to transmit the probe response frame.

In a method of operating an electronic device according to an embodiment, selecting the APs 231, 232, and/or 233 may include selecting APs 231, 232, and/or 233 having the smallest size of data stored in buffers 521, 522, and 523 as APs 231, 232, and/or 233 to transmit the probe response frame in the case that a size of data stored in buffers 521, 522, and 523 of the APs 231, 232, and/or 233 that have received a signal having the highest quality is greater than or equal to a designated size.

In a method of operating an electronic device according to an embodiment, selecting the APs 231, 232, and/or 233 may include selecting APs 231, 232, and/or 233 having the smallest size of data stored in buffers 521, 522, and 523 as APs 231, 232, and/or 233 to transmit the probe response frame.

A method of operating an electronic device according to an embodiment may further include transmitting a quality of the signal measured by at least one AP 231, 232, and/or 233 and identification information of the at least one AP 231, 232, and/or 233 to the selected APs 231, 232, and/or 233. The method of operating an electronic device may further include controlling the selected APs 231, 232, and/or 233 to transmit the probe response frame including a quality of the signal measured by the at least one AP 231, 232, and/or 233 and identification information of the at least one AP 231, 232, and/or 233 to the external electronic device 220.

In a method of operating an electronic device according to an embodiment, the quality of the signal measured by the at least one AP 231, 232, and/or 233 may be included in a target beacon transmission time (TBTT) information field of the probe response frame.

A method of operating an electronic device according to an embodiment may further include controlling the selected APs 231, 232, and/or 233 to transmit a signal including the probe response frame and a quality of a signal measured by the at least one AP 231, 232, and/or 233 to the external electronic device 220.

In a method of operating an electronic device according to an embodiment, the at least one AP 231, 232, and/or 233 may transmit data and/or the probe response frame to the external electronic device 220 through the same channel.

A method of operating an electronic device according to an embodiment may further include determining whether the at least one AP 231, 232, and/or 233 is to transmit the probe response frame based on a status of a link between the external electronic device 220 and the at least one AP 231, 232, and/or 233 and a status of a link between the electronic device and the at least one AP 231, 232, and/or 233.

The electronic device according to an embodiment may include a communication circuit 310. The electronic device may include a processor 320. The electronic device may include a memory 330. The memory 330 may store, when executed by the processor 320, instructions that that cause the electronic device to control the communication circuit 310 so that the electronic device broadcasts a probe request frame. The memory 330 may store instructions that cause the electronic device to receive a probe response frame including identification information of at least one access point (AP) 231, 232, and/or 233 and a quality of a signal measured by each of the at least one AP 231, 232, and/or 233 from any one of at least one AP 231, 232, and/or 233 that has received a signal including a probe request frame. The memory 330 may store instructions that cause the electronic device to access APs 231, 232, and/or 233 corresponding to the highest quality among qualities of a signal.

In the electronic device according to an embodiment, the APs 231, 232, and/or 233 that have transmitted the probe response frame may be APs 231, 232, and/or 233 different from the accessed APs 231, 232, and/or 233.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

1. An electronic device, comprising:
a communication circuit;
a processor operably connected to the communication circuit; and
a memory operably connected to the processor,
wherein the memory is configured to store instructions that, when executed by the processor, cause the electronic device to:
receive, from one or more access points (APs) that have received a probe request frame transmitted by an external electronic device, information related to the probe request frame, the information including at least one signal quality;
select an AP from among the one or more APs to transmit a probe response frame to the external electronic device based on the at least one signal quality and a data size pending in the one or more APs; and
control the selected AP to transmit the probe response frame to the external electronic device.

2. The electronic device of claim 1, wherein the instructions that, when executed by the processor, cause the electronic device to select the AP from among the one or more APs that has received a signal that has a highest signal quality to transmit the probe response frame.

3. The electronic device of claim 2, wherein the instructions that, when executed by the processor, cause the electronic device to select the AP having a smallest data size pending in the AP to transmit the probe response frame in a case that a data size pending in the AP which has received a signal having the highest quality, is greater than or equal to a designated size.

4. The electronic device of claim 1, wherein the instructions that, when executed by the processor, cause the electronic device to select the AP from among the one or more APs that has a smallest data size pending in the AP to transmit the probe response frame.

5. The electronic device of claim 1, wherein the instructions that, when executed by the processor, cause the electronic device to:
transmit at least one signal quality measured by the one or more APs and at least one identification information of the one or more APs to the selected AP; and
control the selected AP to transmit a probe response frame including the at least one signal quality measured by the one or more APs and the at least one identification information of the one or more APs to the external electronic device.

6. The electronic device of claim 5, wherein the at least one signal quality measured by the one or more APs is included in a target beacon transmission time (TBTT) information field of the probe response frame.

7. The electronic device of claim 1, wherein the instructions that, when executed by the processor, cause the electronic device to control the selected AP to transmit a signal including the probe response frame and at least one signal quality measured by the one or more APs to the external electronic device.

8. The electronic device of claim 1, wherein the instructions, when executed by the processor, cause the electronic device to control the one or more APs to transmit data or the probe response frame to the external electronic device through a same channel.

9. The electronic device of claim 1, wherein the instructions that, when executed by the processor, cause the electronic device to determine whether the at least one AP (231, 232, 233) is to transmit the probe response frame based on a status of a link between the external electronic device and the one or more APs and a status of a link between the electronic device and the one or more APs.

10. A method of operating an electronic device, the method comprising:
receiving, from one or more access points (APs) that have received a probe request frame transmitted by an external electronic device, information related to a probe request frame including at least one signal quality;
selecting an AP from among the one or more APs to transmit a probe response frame to the external electronic device based on the at least one signal quality and data size pending in the one or more APs; and
controlling the selected AP to transmit the probe response frame to the external electronic device.

11. The method of claim 10, wherein the selecting the AP comprises selecting the AP from among the one or more APs that has received a signal that has a highest signal quality.

12. The method of claim 11, wherein the selecting the AP comprises selecting the AP having a smallest data size pending in the AP in a case that a data size pending in the AP, which has received a signal having the highest quality, is greater than or equal to a designated size.

13. The method of claim 10, wherein the selecting the AP comprises selecting the AP that has a smallest data size pending in the AP.

14. The method of claim 10, further comprising:
transmitting at least one signal quality measured by the one or more APs and at least one identification information of the one or more APs to the selected AP; and
controlling the selected AP to transmit a probe response frame including the at least one signal quality measured by the one or more APs and the at least one identification information of the one or more APs to the external electronic device.

15. The method of claim 14, wherein the at least one signal quality measured by the one or more APs is included in a target beacon transmission time (TBTT) information field of the probe response frame.

16. The method of claim 10, wherein the instructing the selected AP comprises transmitting a signal including the probe response frame and at least one signal quality measured by the one or more APs to the external electronic device.

17. The method of claim 10, further comprising instructing the one or more APs to transmit data or the probe response frame to the external electronic device through a same channel.

18. The method of claim 10, wherein the selecting the AP is based on at least one link status between the external electronic device and the one or more APs and at least one link status between the electronic device and the one or more APs.

19. An electronic device, comprising:
a communication circuit;
a processor operably connected to the communication circuit; and
a memory operably connected to the processor,
wherein the memory is configured to store instructions that, when executed by the processor, cause the electronic device to:
cause the communication circuit to broadcast a probe request frame,
receive, from one or more access points (APs) that have received a signal including the probe request frame, at least one probe response frame, each probe response frame including identification information of a corresponding AP and signal quality measured by the corresponding AP; and
access an AP that has a highest signal quality among the one or more APs.

20. The electronic device of claim 19, wherein the memory is configured to further store instructions that, when executed by the processor, cause the electronic device to access the AP that has not transmitted the at least one probe response frame.
